(19) United States
(12) Patent Application Publication
(10) Pub. No.: US 2009/0124945 A1
(43) Pub. Date: May 14, 2009

(54) High Efficiency Water Pick Cleaning Apparatus and Showerhead

(76) Inventors: Bonnie E. Reich, Wellington, FL (US); Jerrold Scott Pine, Boca Raton, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 12/263,855

(22) Filed: Nov. 3, 2008

Related U.S. Application Data
(60) Provisional application No. 61/002,146, filed on Nov. 8, 2007.

(51) Int. Cl. A61C 17/02

(52) U.S. Cl. 601/165

(57) ABSTRACT

The inventive pulsating water pick is used in combination with a pulsating showerhead supplied with pressurized water. The showerhead includes rotatable impeller periodically blocking water flow to a fixed regulator plate having circumferentially spaced apart groups of holes. A rotatable control plate—showerhead ejector face plate therebeneath has at least one opening sized to expose one group of holes. Raised lands limit water flow between adjacent plates and depressed areas lead to peripheral shower holes in a peripheral channel. The control plate rotates and plate openings expose hole groups in one mode, but in another, holes are blocked and water flows to depressed areas and the peripheral shower holes in the peripheral channel. The improved pulsating water pick includes a water passage port formed in the control plate and the showerhead ejector face plate, a coupler thereat leading to a tube, a water pick handle and a pick nozzle.

This is a regular patent application based upon and claiming the benefit of provisional patent application Ser. No. 61/002,146, filed Nov. 8, 2007, the contents of which is incorporated herein by reference thereto.

The present invention relates to a shower head with a pulsating water pick attachment.

### BACKGROUND

A traditional water pick uses water pumped under pressure and is directed at teeth, gums, and tongue for oral hygiene. Ideally the water flow through the dental water pick should have sufficient pressure and pulsation to dislodge plaque and food particles from the teeth and gums. Water picks also come with a variety of tips to focus water on cleaning between teeth, on the tongue and other specialized use. Tips are further color coded to distinguish tips for different users. Traditional water picks are equipped with electric piston pumps, where the speed of the motor dictates the rate of pulsation and water pressure expelled from the tip. Traditional water picks are typically used in a bathroom near the sink, and by the end of the cleaning process, leave splatter and residue around the bathroom mirror and sink. The next logical place to perform oral cleaning without the consequence of the mess, is in the shower. This eventually invoked the evolution of the water pick attached to the shower arm/pipe of a showerhead through a diverter valve described in U.S. Pat. No. 4,793,331 to Stewart and U.S. Pat. No. 5,220,914 to Thompson. The new version relied on the household water pressures of 35-60 psi to provide a constant stream of water through the tip of the water pick. It became obvious that a constant stream of water for dislodging food and plaque was not as effective as its pulsating predecessor. The steady stream showerhead/water pick evolved by the addition of impellers and other pulsing means within the water pick branch of the diverter assembly such as U.S. Pat. No. 4,564,005 to Marchand et al and U.S. Pat. No. 5,484,281 to Renow et al. The prior art relies on a separate pulsing means embedded in the water pick branch of the assembly, which is independent of the construction or spraying utilities of the accompanying showerhead. The major issue with the pulsating means provided within the water pick assembly of the prior art, is that by using the small volumetric flow through the water pick to mechanically pulsate the stream, you dissipate too much energy in the mechanical pulsation conversion resulting in a lower water pressure and pulsation frequency coming out of the tip.

What is required is a showerhead/water pick that dissipates minimal energy from the water pick stream which provides a maximum water pressure and pulsation rate to clean your teeth and gums while showering.

### SUMMARY OF THE INVENTION

It is one aspect of the invention to provide a combination showerhead and water pick that operates off of the typical household water supply with a minimum 35 psi supply pressure.

It is another aspect of the invention to provide a pulsating shower stream for massaging showers and a pulsating stream of water for a water pick using a common pulsation means.

It is further aspect of this invention is to provide a valve to adjust the water flow through the water pick from zero flow through maximum flow without effecting the frequency of the pulsation of the water stream.

It is an additional aspect of this invention to provide a means to attach and store the water pick to the shower head while it is not in use.

It is another aspect of this invention to provide a pivot to the storage clip for water pick such that the water pick maintains an essentially vertical orientation with respect to the ground when attached to the shower head as the shower head is adjusted by each user through its adjustable range of motion.

It is a further aspect of this invention to store water pick tip accessories proximal to the water pick in a sanitary enclosure.

It is an additional aspect of this invention to provide a means to keep water pick tips sanitary.

It is another aspect of this invention to provide a showerhead with a plug, said plug can be removed and replaced with an aftermarket water pick assembly.

It is a further aspect of this invention to provide a mirror to guide oral cleansing.

It is an additional aspect of this invention to provide a magnifying mirror to guide oral cleansing.

It is another aspect of this invention to provide a means to reduce or eliminate fogging of said mirror.

It is a further aspect of this invention to make the mirror attachably detachable to said showerhead.

It is another aspect of this invention to provide suitable attachment to the water pick for an ear lavage.

It is an additional aspect of this invention to dispense mouthwash or other cleansing agents though the water pick.

It is another aspect of this invention to provide a timer indicative of adequate oral cleansing time.

It is a further aspect of this invention to provide accessories for the water pick to clean grout and tiles in the shower.

It is another aspect of this invention to provide an extension hose for said water pick.

It is an additional aspect of this invention to provide a detachably attachable water pick.

The inventive pulsating water pick is used in combination with a pulsating showerhead supplied with pressurized water. The showerhead includes an outer housing defining an input port and an internal chamber supplied with pressurized water. A rotatable impeller is mounted in the outer housing and has a plurality of radially extending fins mounted on an impeller plate. The impeller plate has partially blocking circumferential segments such that water flow causes said impeller to rotate due to blocked flow about said partially blocking circumferential segments. The impeller is rotatably mounted atop a fixed regulator plate which is fixed in said outer housing. The regulator plate has a plurality of groups of holes. Each group of holes being a plurality of holes and each group circumferentially spaced apart about the regulator plate. The showerhead also includes a control plate beneath the regulator plate. The regulator plate is intermediate the impeller and the control plate. The control plate is rotatably mounted in the outer housing and forms a showerhead ejector face plate. The control plate has at least one opening sized to expose one group of said plurality of holes in the regulator plate. The control plate includes raised lands which closely interface with the regulator plate to limit water flow therebetween. The control plate also defines depressed areas leading to peripheral shower holes and a peripheral channel in the control plate. The control plate is subject to rotation by a user such that when the control plate openings expose one group of plurality of holes, water flows therethrough but when the group of holes is adjacent the depressed areas formed by the control plate, water flows through the depressed areas and not through the group of holes but rather flows to the peripheral shower holes in the peripheral channel. The peripheral shower holes eject water from the head ejection face (an exterior surface of the control plate). The larger openings in the control plate permit unrestricted passage of all water direct from the exposed group of holes in the regulator plate.

The improved pulsating water pick including a water passage port formed in said control plate and a coupler, mounted on said showerhead ejector face plate. The coupler or diversion housing provides a fluid coupling to a tube. The improved water pick further includes a water pick handle and a pick nozzle at the distal end of the tube opposite said coupler. A valve in the pick handle controls water flow to the pick nozzle.

### BRIEF DESCRIPTION OF THE FIGURES

Further objects of the present invention can be found in the detailed description of the preferred embodiments when taken in conjunction with the accompanying drawings in which:

FIG. 1 diagrammatically illustrates the prior art of U.S. Pat. No. 5,220,914. It contains a showerhead 1 with a diverter valve 30 that allows water to flow into tube 70 to handle 8 and through water pick tip 48.

FIG. 2 diagrammatically illustrates the prior art of U.S. Pat. No. 5,484,281. It contains many features from U.S. Pat. No. 5,220,914 and adds an impeller 50 to pulsate the water flowing towards the water pick tip 48. The content of U.S. Pat. No. 5,484,281 is incorporated herein by reference thereto.

FIGS. 3 and 4 diagrammatically illustrates illustrate alternative impeller configurations of the prior art.

FIG. 5 diagrammatically illustrates is an exploded diagram of the components inside a typical pulsating showerhead modified in accordance with the principles of the present invention.

FIG. 6 diagrammatically illustrates a front view of an assembled showerhead and water pick in accordance with the principles of the present invention.

FIG. 7 diagrammatically illustrates that clip 40 is contoured to the geometry of handle 8a so the clip freely captures then releases the handle 8a with a vertical motion of handle 8a in accordance with the principles of the present invention.

FIG. 8 diagrammatically illustrates the addition of mirror 24 in accordance with the principles of the present invention.

### DETAILED DESCRIPTION OF THE PREFERRED EMBODIMENTS

The present invention relates to a showerhead with a pulsating water pick attachment. Similar numerals designate similar items throughout the drawings and the specification.

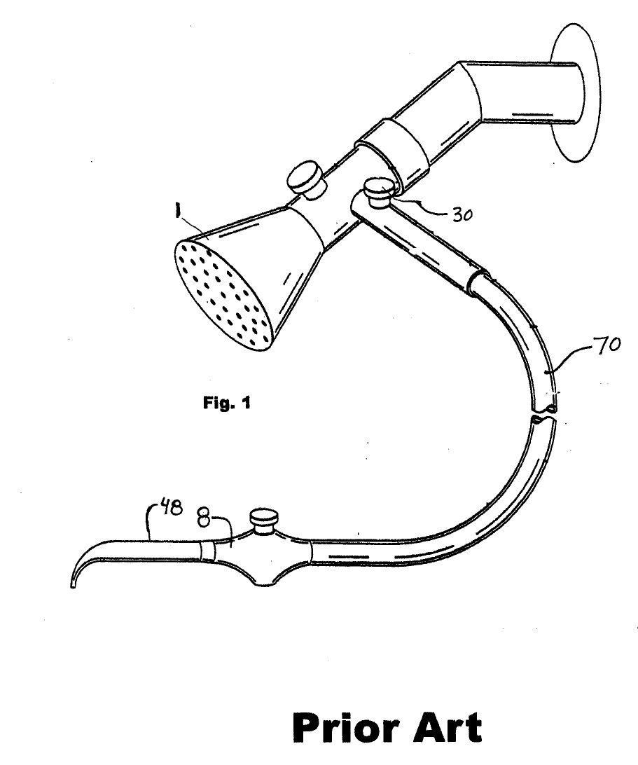

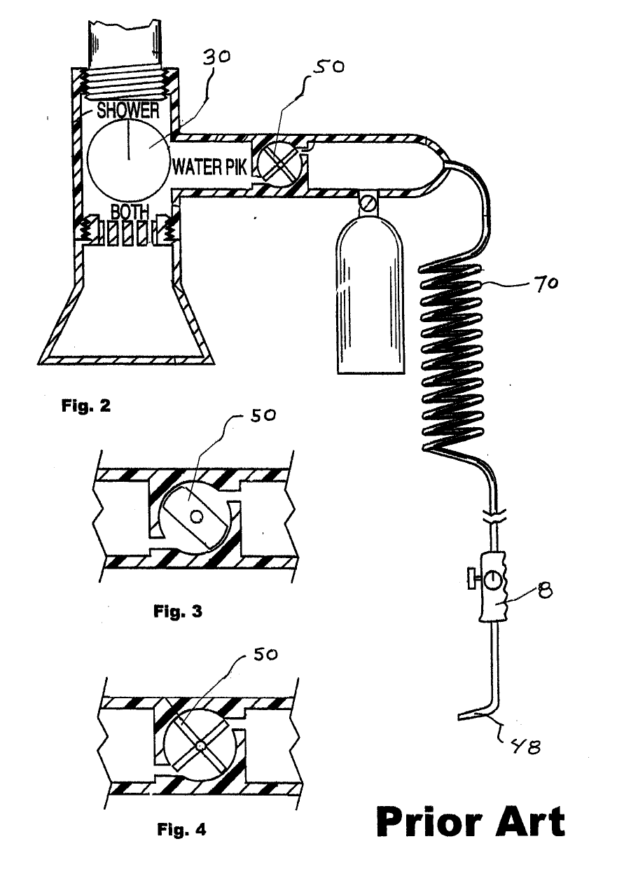

FIGS. 1-4 diagrammatically illustrate prior art. FIG. 1 diagrammatically illustrates the prior art of U.S. Pat. No. 5,220,914, the disclosure of which is incorporated herein by reference thereto. It contains a showerhead 1 with a diverter valve 30 that allows water to flow into tube 70 to handle 8 and through water pick tip 48. FIG. 2 diagrammatically illustrates the prior art of U.S. Pat. No. 5,484,281. It includes several features from U.S. Pat. No. 5,220,914 and adds an impeller 50 to pulsate the water flowing towards the water pick tip 48. FIGS. 3 and 4 diagrammatically illustrate alternative impeller configurations of the prior art.

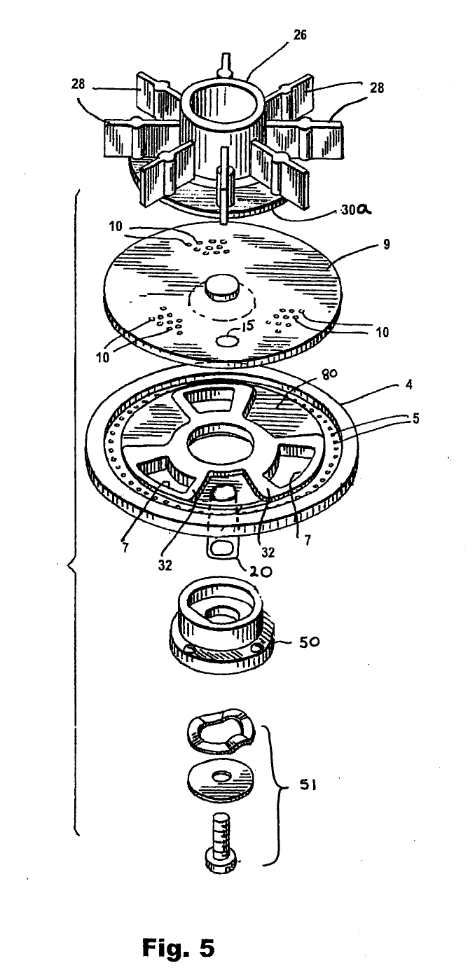

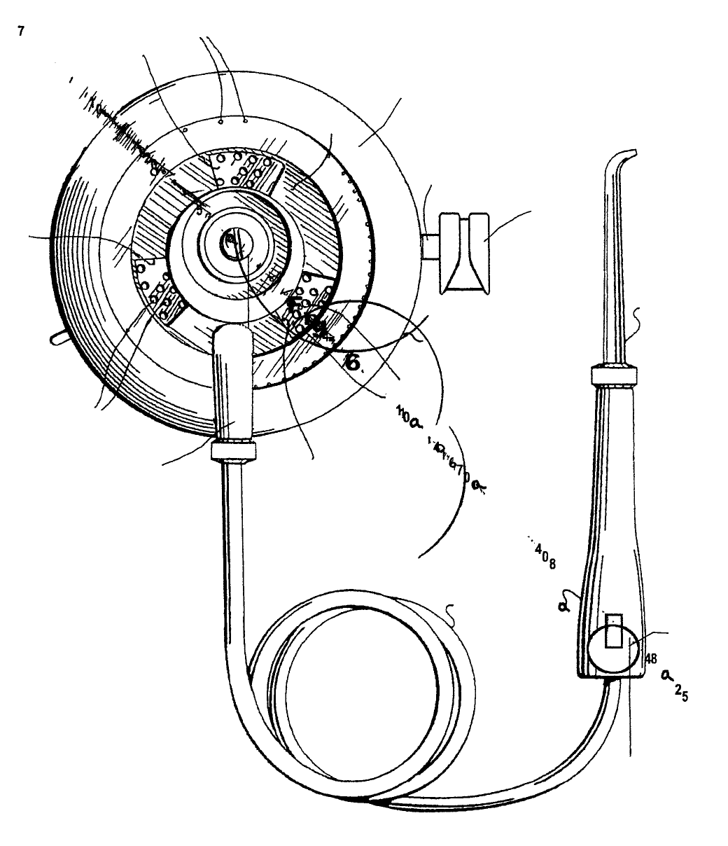

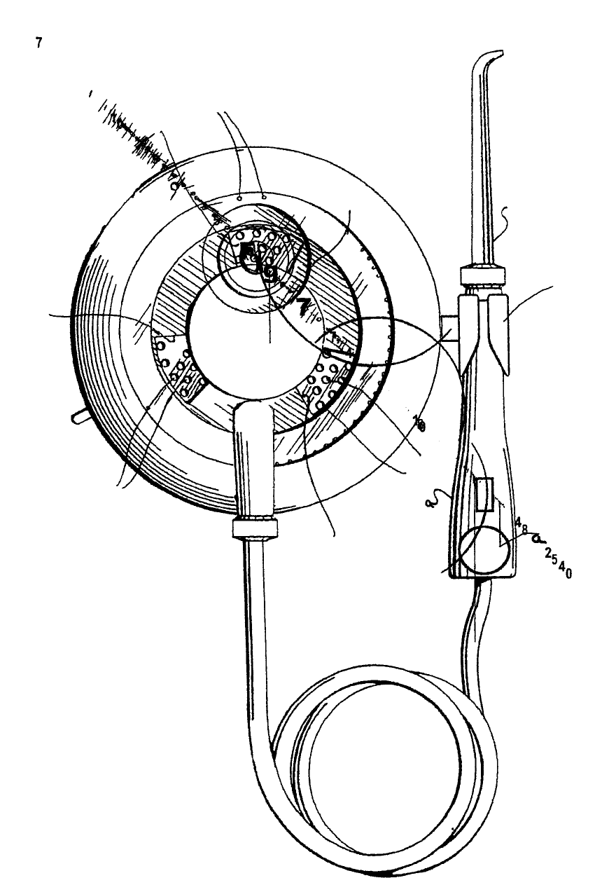

FIG. 5 diagrammatically illustrates is an exploded diagram of the components inside a typical pulsating showerhead modified in accordance with the principles of the present invention. The water pick pulsations are implemented using impeller 26 that has fins 28 wherein the impeller 26 rotates on plate 9. Plate 9 is a regulator plate fixed in the outer housing 106 (FIG. 6). Impeller 26 has a protrusion plate 30a perpendicular to the fins 28. Protrusion plate 30a partially blocks the path of water and forces the water to flow around half of the circumference of the impeller 26. Protrusion plate 30a has circumferential cut outs (shown between the fins at clock face locations 9:00 and 10:30; 10:30 and 12:00; 12:00 and 1:30; 1:30 and 3:00) and circumferential blocking plate elements which blocking plate elements are shown in FIG. 5. See, for example, the blocking segment at fins 4:30 and 6:00. Therefore, radial segments between four of the impeller fins 28 are open whereas blocking plate elements limit water flow between the remaining four impeller fins 28. As pressurized water from the bathroom plumbing strikes fins 28, the water causes impeller 26 to rotate about plate 9 as water passes through an interior chamber housing the impeller (for example, housing 106 in FIG. 6). In a normal mode of operation for the pulsating showerhead, the impeller 26 rotates on plate 9 and thus periodically aligns portions of the impeller 26 not blocked by protrusion plate 30a with a portion of holes 10 in regulator plate 9 allowing water to pass through the holes and out of the showerhead. As impeller 26 continues to rotate, the portion of holes 10 that allow water to flow are cyclically blocked then unblocked by blocking plate elements of plate 30a causing the water to flow through holes 10 and to pulsate.

As per the principles of the present invention, hole 15 is added in regulator plate 9 between group holes 10 as a port for pulsating water to flow through hole 15 into diverter housing 20. The pulsating shower head further includes a control plate 4 which is rotated by the user. Control plate 4 has openings 7 and lands 32 and stop plates 80. The control plate 4 forms a showerhead ejector face plate. See FIG. 6. When the user rotates control plate 4 and aligns large openings 7 with holes 10 of plate 9, a substantial amount of water passes through the holes 10 and out of openings 7. The opening 7 is larger than any single group of holes 10. The stop plates 80 in the control plate create a depression region lower than the raised interfacing lands 32. When the holes 10 are aligned adjacent the depressed stop plates 80, water does not flow out openings 7 but rather flows in the depression and out of peripheral holes 5 in the outer periphery of the control plate 4. Peripheral holes 5 reside in a peripheral channel. The lands 32 coact with and are interfacing with regulator plate 9 such that the lands limit water flow to either the depressed region at stop plates 80 or out of large openings 7.

Diversion hole 15 is aligned, upon proper rotation by the user of control plate 4, with a diversion port in the control plate. The diversion port is in the depression area above one of the stop plates 80. When the user rotates control plate 4 to direct water flow out of peripheral holes 5, a portion of this pulsating water is fed into diversion hole 15 and diversion port and out of diversion housing 20. The diversion hole 15 may be located on the periphery of the control plate 4 rather than on the exposed, water spraying face.

Control plate 4 is rotatably held in place in the housing 106 (FIG. 6) by collar 50 and spring washer and flat washer and screw set 51.

From diversion housing 20, the pulsating water is fed into water pick tube 70a through rotary ball valve 25 through handle 8a and out water pick tip 48a. Although rotary ball valve 25 controls the rate of water flow to the water pick tip 48a, its closure has no effect on the frequency of pulsations since the primary flow of water is out the showerhead. See the control plate 4 face in FIG. 6.

This local control of the pulsating water from the tip 48a, without altering the shower head performance, is the main improvement over prior art in FIGS. 2, 3 and 4. In the prior art, as water flow to the water pick tip 48a is regulated by diverter valve 30, the frequency of the pulsations out of the tip will decrease as the flow decreases. Many times people with sensitive teeth may begin therapy with a lower water pressure/flow, and then increase it over time. The frequency of the pulsations which help dislodge food and plaque need to stay above a threshold to maintain the intended cleansing effect. The prior art fails to meet this need.

The diversion housing 20 is coupled to tube 70a thereby permitting pulsating water flow from hole 15 to be diverted through the diversion port in control plate 4 off the face of the showerhead. Diversion housing 20 can be attached to a closeable port in control plate 4 with a fastener, screw or snap fit feature on the showerhead housing 106 (FIG. 6). Diversion housing 20 can be removed and replaced with a plug to allow the water pick feature to be an optional aftermarket accessory. The plug would snap, screw or be fastened to the port thereby enabling an after-market water pick accessory.

FIG. 6 shows diversion housing 20 on the ejector face of showerhead housing 106.

Water pick tip 48a can come in various configurations including a small brush tip which could be used to brush teeth, or an alternative use of a brush tip could be to clean mold or grime off of tile grout. The tip 48a may have a tip geometry appropriate for ear lavage which would inject water into the ear but not seal with or intrude into the ear canal to prevent pressurization of the ear canal. The base of the tips 48a can be color coded or have unique geometrically shapes such as circular, square, hexagonal etc. to identify different users. The tips are configured to eject water in a different ejection pattern for different cleaning modularities such as ear lavage, small brush tip, clean mold tip, etc. The tips are generally injection molded, and could have silver powder or be doped with other anti-bacterial formulations to make the tips sanitary. The tips would be typical of those well known in the art, and may include various features to snap fit them into the handle 8a making them attachably detachable and may include the addition of an o-ring to make the attachment water tight. The tips could be stored in a plastic enclosure where the tips in storage ate isolated from dust and water intrusion to help keep them more sanitary. The enclosure may be fastened to a wall in the shower for easy access.

A sub assembly comprising tube 70a and handle 8a may be fitted with appropriate coupling to place it in series with another tube 70a and handle 8a (not shown) to create an extension hose to achieve greater reach then a single tube 70a would allow. The handle 8a may have a chamber and a port integrated into it to fill the handle with mouthwash or other cleansing agent that will be dispensed through the tip 48a when water flows through the handle using the venturi vacuum from the flow to dispense the cleansing agent. See U.S. Pat. No. 5,484,281. The handle may also have a waterproof timer and controls built in to indicate the minimum time for cleaning your teeth. The timer may be electronic or wind up, or any other well known means for timing and providing feedback that a given amount time has expired. The feedback may be visual or auditory.

FIG. 6 also illustrates clip 40 with pivot attachment 41.

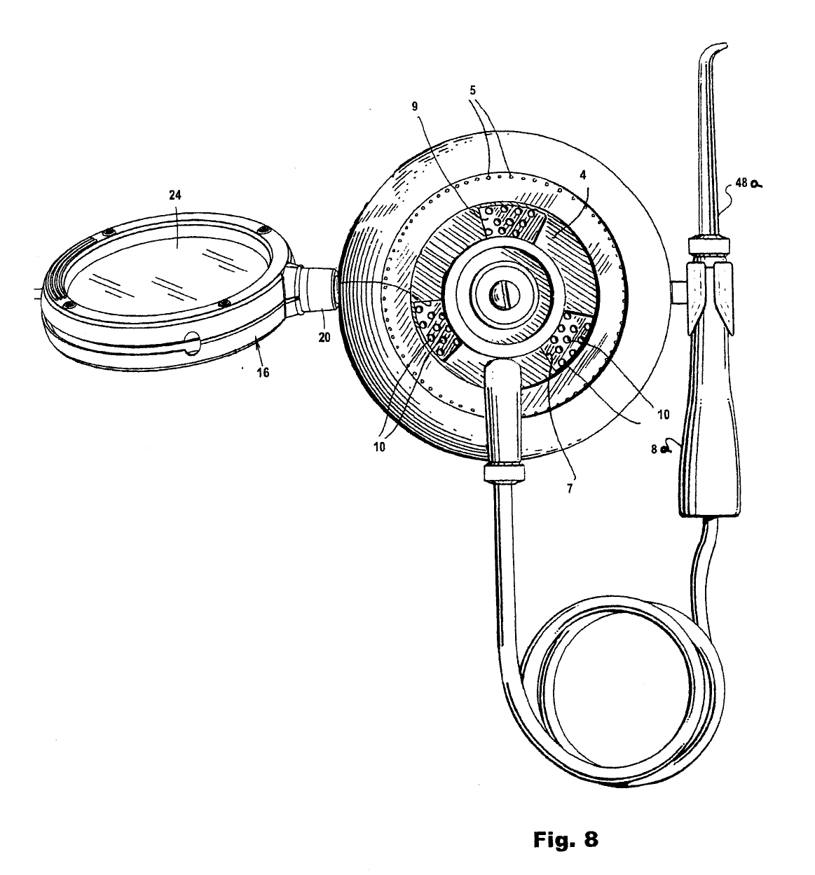

FIG. 7 diagrammatically illustrates that clip 40 is contoured or complementary to the geometry of handle 8a so it freely captures then releases the handle 8a with a vertical motion of handle 8a. The clip 40 allows handle 8a to be supported for storage when not in use. As the showerhead is angled towards the floor, the pivot attachment 41 for the water pick handle 8a allows the holstered handle 8a to freely rotate to a vertical position.

FIG. 8 diagrammatically illustrates the addition of mirror 24. Mirror 24 is attached to showerhead via rotating coupling 20 which can be attached and detached. Mirror 24 can be a plano mirror or concave mirror for magnifying an image. The mirror assembly 16 can have a plano mirror on one side and a magnifying mirror on the opposite to allow the user to select the appropriate mirror by rotating the assembly 180 degrees. The mirrors can be coated with an anti fog surfactant.

It will thus be seen that the objects set forth above, and those made apparent from the preceding descriptions, are effectively attained and since certain changes may be made in the above construction without departing from the spirit and scope of the invention, it is intended that all matter contained in the above description or shown in the accompanying drawings, shall be interpreted as illustrative and not in a limiting sense. The claims appended hereto are meant to cover modifications and changes within the scope and spirit of the present invention.

What is claimed is:

1. A pulsating water pick in combination with a pulsating showerhead supplied with pressurized water, said showerhead including an outer housing defining an input port and an internal chamber therein supplied with said pressurized water, a rotatable impeller disposed in said chamber and having a plurality of radially extending fins mounted on an impeller plate having partially blocking circumferential segments such that water flow causes said impeller to rotate due to blocked flow about said partially blocking circumferential segments, said impeller rotatably mounted on a fixed regulator plate fixed in said outer housing, said regulator plate having a plurality of groups of holes, each group of holes being a plurality of holes and each group circumferentially spaced apart about said regulator plate, said showerhead having a control plate beneath said regulator plate such that said regulator plate is intermediate said impeller and said control plate, said control plate rotatably mounted in said outer housing and forming a showerhead ejector face plate, said control plate having at least one opening sized to expose one group of said plurality of holes in said regulator plate, said control plate including raised lands which closely interface with said regulator plate to limit water flow therebetween and said control plate defining depressed areas leading to peripheral shower holes and a peripheral channel, said control plate subject to rotation by a user such that when said openings expose said one group of plurality of holes, water flows therethrough but when said one group of plurality of holes is adjacent said depressed areas, water flows therethrough to said peripheral shower holes in said peripheral channel, the improved pulsating water pick comprising:
a water passage port formed in said control plate;
a coupler, mounted on said showerhead ejector face plate, providing fluid coupling to a tube;
a water pick handle and a pick nozzle at the distal end of the tube opposite said coupler; and
a valve in said pick handle for controlling water flow to said pick nozzle.

2. The pulsating water pick in combination with the pulsating showerhead as claimed in claim 1 including a plurality of nozzles, each nozzle configured to eject water in a different ejection pattern for different cleaning modularities.

3. The pulsating water pick in combination with the pulsating showerhead as claimed in claim 1 including a handle coupler mountable to said showerhead, said handle coupler having a complementary shape to mate with said water pick handle.

4. The pulsating water pick in combination with the pulsating showerhead as claimed in claim 3 including a handle coupler mountable to said showerhead, said handle coupler having a complementary shape to mate with said water pick handle.
